(19) United States
(12) Patent Application Publication
(10) Pub. No.: US 2020/0302426 A1
(43) Pub. Date: Sep. 24, 2020

(54) BLUETOOTH FINANCIAL CARD AND WORKING METHOD THEREFOR

(71) Applicant: Feitian Technologies Co., Ltd., Beijing (CN)

(72) Inventors: Zhou Lu, Beijing (CN); Huazhang Yu, Beijing (CN)

(21) Appl. No.: 16/648,283

(22) PCT Filed: Nov. 28, 2018
(86) PCT No.: PCT/CN2018/117818

§ 371 Date: Mar. 18, 2020

(30) Foreign Application Priority Data
Dec. 11, 2017 (CN) 201711306185.9

(51) Int. Cl. G06Q 20/34; G06Q 20/40; G06Q 20/42; G06Q 20/38; H04L 9/32

(52) U.S. Cl. CPC G06Q 20/3415; G06Q 20/352; G06Q 20/3574; G06Q 20/40145; G06Q 20/4016; G06Q 2220/00; G06Q 20/38215; G06Q 20/4012; H04L 9/3231; H04L 9/3234; G06Q 20/42

(57) ABSTRACT

A Bluetooth financial card, belonging to the field of information security, and comprising a receiving module, an acquisition module, a first execution module, a selection module, a cardholder verification module, a second execution module, an online transaction message organization sending module, an authorization response receiving module, and a transaction confirmation message organization sending module. The technical solution disclosed in the present invention overcomes the defects that the existing contact-type financial cards and contactless-type financial cards are inconvenient to operate in a transaction process, improving the working efficiency, and also saving on the manufacturing cost. The Bluetooth financial card communicates with an upper computer via Bluetooth, which makes the transaction operation more convenient; and when using a fingerprint verification type of cardholder verification method, the transaction is more convenient and secure.

### FIELD OF THE INVENTION

The present disclosure relates to a Bluetooth financial IC card and a working method thereof, which belongs to the field of information security technology.

### PRIOR ART

With the rapid development of the electronic information technology, the electronic transaction becomes more popular in daily life. In prior art, there are two kinds of financial IC card, one of them is a contact financial IC card which communicates with a terminal via chip contractor and magnetic strip, the other is contactless financial IC card which communicates with the terminal contactless via antenna coil. In prior art, a card holder authentication needs to be operated in the electronic transaction to make the electronic transaction more security; most of the methods for authenticating the card holder include a method for off-line authenticating identifying code and a method for on-line authenticating identifying code; in both of methods, a user needs to enter identifying information into the terminal, which means in the method for off-line authenticating identifying code, the user need to enter an off-line identifying code in the terminal; and in the method for on-line authenticating identifying code, the user needs to enter an on-line identifying code.

The disadvantages in the prior art include that the contact financial IC card needs to contact the terminal when they communicate with each other, if the two parts cannot contact perfect, the transaction cannot be successful, thus the operation becomes inconvenient; and the contactless financial IC card needs to within an effective communication range when the card and the terminal communicate with each other, if the contactless financial IC card is not within the range, the transaction cannot be operated, and at the moment, the contactless should contact the terminal to communicate, thus, it is not convenient for a user.

When the card holder is identified, the user needs to enter identifying information, which are the off-line identifying code or the on-line identifying code, in the terminal, so that it is possible that the identifying information would be taken by others, thus making chance for someone who plans to illegally stole the identifying information; on one hand, the identifying information, the off-line identifying code or the on-line identifying code, is easily forgotten, on the other hand, once the user forgets the identifying information, an electronic transaction cannot be continued, so it is very inconvenient for the users.

Last but not least, the transaction terminal and the financial IC card are separated from each other. In this case, in the process of making the prior art financial IC card, a manufacturer of the financial IC card and a manufacturer of the transaction terminal must be coordinated with each other, thus increasing a cost for coordinating activities between different product makers. Moreover, the transaction terminal and the financial IC card are independent devices, which are both expensive, thus the cost for making the devices for realizing electronic transaction is high.

### SUMMARY OF THE INVENTION

The object of the present invention is to provide a Bluetooth financial IC card and a working method of Bluetooth financial IC card, which is easier to operate, works more effectively, and cheaper in manufacturing and makes the transaction more convenient and safer.

Thus, according to one aspect of the present invention, there is provided a working method for Bluetooth financial IC card, which comprises that

Step S1, receiving, by the Bluetooth financial IC card, a transaction instruction via Bluetooth from an upper computer, obtaining transaction data from the transaction instruction;

Step S2, executing, by the Bluetooth financial IC card, an application chosen operation, executing an application initialization, executing a reading data operation to obtain data, and choosing a card holder authenticated method according to a card holder authenticated methods list in the application data, the card holder authenticated methods list includes the card holder authenticated method of fingerprint authenticated type;

Step S3, executing, by the Bluetooth financial IC card, a terminal risk management, executing an action analysis operation according to the application data and the transaction data, and executing Step S4 in the case that an application cryptogram in an action analysis result is an authorization request cryptogram;

Step S4, organizing, by the Bluetooth financial IC card, an on-line transaction message, and sending the on-line transaction message to the upper computer via Bluetooth; and

Step S5, receiving, by the Bluetooth financial IC card, an authorization response from the upper computer via Bluetooth, organizing a transaction confirmation message, and sending the transaction confirmation message to the upper computer via Bluetooth, ending the method.

Preferably, the method further includes in the case that the application cryptogram in the action analysis result is the transaction certificate, executing the operations as follows:

the Bluetooth financial IC card organizes the off-line transaction blog, and sends the off-line transaction blog to the upper computer via Bluetooth; or

the Bluetooth financial IC card organizes the off-line transaction blog, and stores the off-line transaction blog.

According to the other aspect of the present invention, there is provided a Bluetooth financial IC card, comprising

a receiving module, which is configured to receive a transaction instruction from an upper computer via Bluetooth;

an obtaining module, which is configured to obtain transaction data from the transaction instruction received by the receiving module;

a first executing module, which is configured to execute an application choice operation, execute an application initialization, and execute reading application data to obtain application data after the obtaining module obtains the transaction data;

a choosing module, which is configured to choose a card holder authenticated method according to a card holder authenticated methods list in the application data obtained by the first executing module; the card holder authenticated methods list includes a card holder authenticated method of fingerprint authenticated type;

the card holder authenticating module, which is configured to execute the card holder authenticated operation according to the card holder authenticated method chosen by the choosing module;

a second executing module, which is configured to execute a terminal risk management and execute an action analysis operation according to the application data obtained by the first executing module and the transaction data obtained by the obtaining module after the card holder authenticating module executes the card holder authenticated operation according to the card holder authenticated method chosen by the choosing module;

an on-line transaction message organizing and sending module, which is configured to organize an on-line transaction message, and to send the on-line transaction message to the upper computer via Bluetooth in the case that an application cryptogram in a result of action analysis operation executed by the second executing module is an authorization request cryptogram;

an authorization response receiving module, which is configured to receive an authorization response via Bluetooth after the on-line transaction message organizing and sending module sends the on-line transaction message to the upper computer via the Bluetooth; and

a transaction confirmation message organizing and sending module, which is configured to organize the transaction confirmation message and send the transaction confirmation message to the upper computer via Bluetooth after the authorization response receiving module receives the authorization response.

Preferably, the Bluetooth financial IC card further includes an off-line transaction blog organizing module;

the off-line transaction blog organizing module is configured to organize the off-line transaction blog in the case that the application cryptogram in the action analysis result obtained by the second executing module is the transaction certificate;

the Bluetooth financial IC card further includes an off-line transaction sending module and an off-line transaction blog storing module;

the off-line transaction blog sending module is configured to send the off-line transaction blog organized by the off-line transaction blog organizing module to the upper computer via Bluetooth; and

the off-line transaction blog storing module is configured to store the off-line transaction blog organized by the off-line transaction blog organizing module.

Compared with the prior art, the Bluetooth financial IC card includes both functions of a financial IC card and a transaction terminal in the present disclosure, so it does not need to contacting or contactless communicate with the transaction terminal in the transaction, overcoming the inconvenience in contact financial IC card transaction and in contactless financial IC card transaction, thus, making the work more efficient and lowering the cost. Especially, with communication between the Bluetooth financial IC card and the upper computer, it becomes more convenient for performing the transaction. Meanwhile, the transaction becomes more convenient and more security when the fingerprint authenticated type is used.

### BRIEF DESCRIPTION OF THE DRAWINGS

FIG. 1 shows a flow diagram of a working method of a Bluetooth financial IC card according to Embodiment 1 of the present invention;

FIG. 2-FIG. 3 show a flow diagram of a transaction method according to Embodiment 2 of the present invention;

FIG. 4 shows a block diagram of modules in a Bluetooth financial IC card according to Embodiment 3 of the present invention.

### PREFERRED EMBODIMENTS

The technical solution in the Embodiments of the present invention is further described more clearly and completely with the drawings of the present invention. Apparently, Embodiments described herein are just a few Embodiments of the present invention. On the basis of Embodiments of the invention, all other related Embodiments made by those skilled in the art without any inventive work belong to the scope of the invention.

In this disclosure, the upper computer can be a mobile smart terminal, i.e. a mobile phone or non-mobile smart terminal, i.e. a computer.

### Embodiment 1

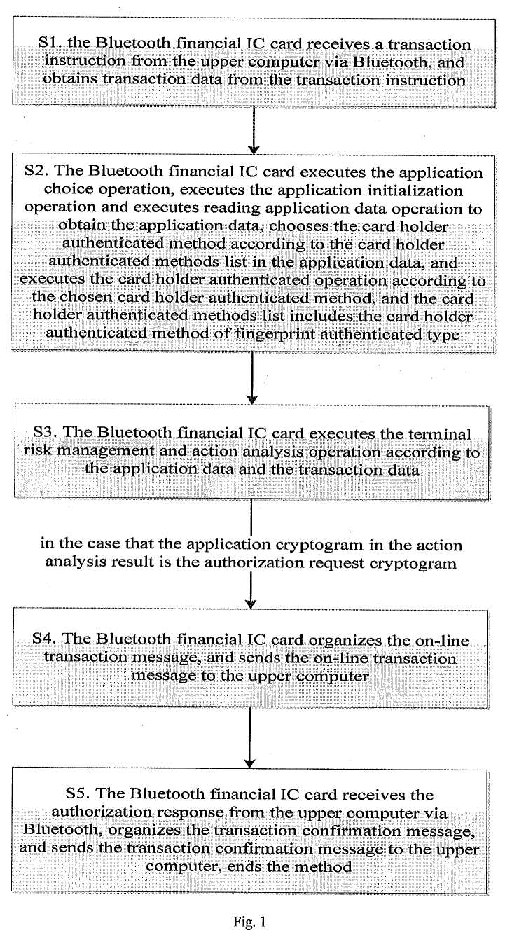

It provides a working method of a Bluetooth financial IC card according to Embodiment 1, as shown in FIG. 1, which includes

Step S1, the Bluetooth financial IC card receives a transaction instruction from an upper computer via Bluetooth, and obtains transaction data from the transaction instruction;

Step S2, the Bluetooth financial IC card executes an application choice, executes an application initialization, executes application data reading and obtaining, chooses a card-holder authenticated method according to a card-holder authenticated methods list in the application data, and authenticates the card-holder according to the card-holder authenticated method which is chosen, and the card-holder authenticated methods list includes the card-holder authenticated method of fingerprint authenticated type;

Step S3, the Bluetooth financial IC card executes a terminal risk management and an action analysis according to the application data and the transaction data, and executes Step S4 in the case that an application cryptogram in a result of the action analysis is an authorization request cryptogram;

Step S4, the Bluetooth financial IC card organize an on-line transaction message, and sends the on-line transaction message to the upper computer via Bluetooth; and

Step S5, the Bluetooth financial IC card receives an authorization response from the upper computer via Bluetooth, organizes a transaction confirmation message, and sends the transaction confirmation message to the upper computer via Bluetooth, ends the method.

Preferably, said method further includes that in the case that the application cryptogram in the result of the action analysis is a transaction certificate, executes the following operations:

the Bluetooth financial IC card organizes an off-line transaction blog, and sends the off-line transaction blog to the upper computer via Bluetooth; or, the Bluetooth financial IC card organizes the off-line transaction blog, and saves the off-line transaction blog.

Preferably, before Step S1, the method further includes that

Step S0, the Bluetooth financial IC card receives a transaction authenticating instruction from the upper computer, prompts the user to authenticate the transaction according to the transaction authenticating transaction, authenticates the transaction authenticating information entered by the user after the transaction authenticating information is received, returns an authentication successful response to the upper computer in the case that the transaction authenticating information is authenticated successfully; otherwise, returns an authentication fail response to the upper computer, and ends the transaction.

Specifically, Step S0 includes that

Step S01, the Bluetooth financial IC card receives a fingerprint authenticated instruction from the upper computer, and prompts the user to enter fingerprint information;

Step S02, the Bluetooth financial IC card receives the fingerprint information entered by the user;

Step S03, the Bluetooth financial IC card authenticates the fingerprint information entered by the user according to fingerprint information stored in the Bluetooth financial IC card, generates authentication successful information in the case that the fingerprint information entered by the user is authenticated successfully, and returns the authentication successful information to the upper computer; otherwise, generates authentication fail information, and returns the authentication fail to the upper computer, then ends the transaction.

In Embodiment 1, in the case that the card-holder authenticated method chosen by said Bluetooth financial IC card is the on-line fingerprint authenticated type, said executing the card-holder authenticating according to the card-holder authenticated method chosen specifically is that the Bluetooth financial IC card generates a third fingerprint eigenvalue, encrypts the third fingerprint eigenvalue to obtain an encrypted third fingerprint eigenvalue; correspondingly, the on-line transaction message comprises the encrypted third fingerprint eigenvalue.

In Embodiment 1, in the case that the card-holder authenticated method chosen by the Bluetooth financial IC card is the off-line fingerprint authenticated type, said executing the card-holder authenticating according to the card-holder authenticated method chosen specifically is that the Bluetooth financial IC card generates a successful off-line fingerprint authenticated result according to authenticating successful information; correspondingly, the on-line transaction message includes the successful off-line fingerprint authenticated result, an on-line identifying code stored in the Bluetooth financial IC card; or, the on-line transaction message includes the successful off-line fingerprint authenticated result.

In Embodiment 1, in the case that the card-holder authenticated method chosen by the Bluetooth financial IC card is the off-line fingerprint authenticated type, said executing card-holder authenticating according to the card-holder authenticated method chosen specifically is that the Bluetooth financial IC card generates the successful off-line fingerprint authenticated result according to the authenticating successful information; correspondingly, said off-line transaction blog includes the successful off-line fingerprint authenticated result.

Or, specifically, Step S0 specifically includes:

Step L01, the Bluetooth financial IC card receives an identifying code authenticated instruction from the upper computer, prompts the user to enter a transaction identifying code;

Step L02, the Bluetooth financial IC card obtains the transaction identifying code entered by the user;

Step L03, the Bluetooth financial IC card authenticates the transaction identifying code entered by the user according to the transaction identifying code stored by the Bluetooth financial IC card, generates the authenticating successful information and returns the authenticating successful information to the upper computer in the case that the transaction identifying code entered by the user is authenticated successfully; otherwise, generates the authenticating fail information and returns the authenticating fail information to the upper computer then ends the method.

In Embodiment 1, in the case that the card-holder authenticated method chosen by the Bluetooth financial IC card is the off-line identifying code authenticated type, said executing the card-holder authenticated operation according to the card-holder authenticated method specifically is that the Bluetooth financial IC card generates the successful off-line identifying code authenticated result according to the authenticating successful information; correspondingly, said on-line transaction message includes the successful off-line identifying code authenticated result and the on-line identifying code stored in the Bluetooth financial IC card; or, the on-line transaction message includes the successful off-line identifying code authenticated result.

In Embodiment 1, in the case that the card-holder authenticated method chosen by the Bluetooth financial IC card is the off-line identifying code authenticated type, the executing card-holder authenticated operation according to the chosen card-holder authenticated method specifically is that the Bluetooth financial IC card generates the successful off-line identifying code authenticated result according to the authenticating successful information; correspondingly, said off-line transaction blog includes the off-line identifying code authenticated successful result.

Preferably, in Step S2, in the case that the card-holder authenticated method chosen by the Bluetooth financial IC card is the off-line identifying code authenticated type, said executing card-holder authenticated operation according to the chosen card-holder authenticated method specifically includes that

Step c11, the Bluetooth financial IC card prompts the user to enter an off-line identifying code;

Step c12, the Bluetooth financial IC card obtains the off-line identifying code entered by the user;

Step c13, the Bluetooth financial IC card authenticates the off-line identifying code entered by the user according to the off-line identifying code stored in the Bluetooth financial IC card, and generates the off-line identifying code authenticated result.

Or, in Step S2, in the case that the card-holder authenticated method chosen by the Bluetooth financial IC card is the off-line fingerprint authenticated type, said executing the card-holder authenticated operation according to the chosen card-holder authenticated method specifically includes that

Step d11, the Bluetooth financial IC card prompts the user to enter fingerprint information;

Step d12, the Bluetooth financial IC card obtains the fingerprint information entered by the user;

Step d13, the Bluetooth financial IC card authenticates the fingerprint information entered by the user according to the fingerprint information stored in the Bluetooth financial IC card, and generates the off-line fingerprint authenticated result.

Furthermore, in the case that the off-line fingerprint authenticated result is the successful off-line fingerprint authenticated result, said on-line transaction message includes the successful off-line fingerprint authenticated result, and the on-line identifying code stored in the Bluetooth financial IC card;

In the case that the off-line fingerprint authenticated result is a failure off-line fingerprint authenticated result, said on-line transaction message includes the failure off-line fingerprint authenticated result.

Or, in Step S2, in the case that the card-holder authenticated method chosen by the Bluetooth financial IC card is the on-line fingerprint authenticated type, said executing the card-holder authenticated operation according to the chosen card-holder authenticated method specifically includes that:

Step e11, the Bluetooth financial IC card prompts the user to enter fingerprint information;

Step e12, the Bluetooth financial IC card obtains the fingerprint information entered by the user;

Step e13, the Bluetooth financial IC card generates the third fingerprint eigenvalue, encrypts the third fingerprint eigenvalue to obtain the encrypted third fingerprint eigenvalue; correspondingly, the on-line transaction message includes the encrypted third fingerprint eigenvalue.

Or, in Step S2, in the case that the card-holder authenticated method chosen by the Bluetooth financial IC card is the on-line identifying code authenticated type, said executing the card-holder authenticated operation according to the chosen card-holder authenticated method specifically includes that

Step f11, the Bluetooth financial IC card prompts the user to enter an on-line identifying code;

Step f12, the Bluetooth financial IC card obtains the on-line identifying code entered by the user;

Step f13, the Bluetooth financial IC card encrypts the on-line identifying code entered by the user to obtain an encrypted on-line identifying code; correspondingly, the on-line transaction message includes the encrypted on-line identifying code.

Preferably, before the Bluetooth financial IC card is turned on, the method further includes that the Bluetooth financial IC card executes a turning-on authenticated operation.

Specifically, the Bluetooth financial IC card executing the turning-on authenticated operation includes that

Step 11, the Bluetooth financial IC card prompts the user to enter fingerprint information;

Step 12, the Bluetooth financial IC card obtains the fingerprint information entered by the user;

Step 13, the Bluetooth financial IC card authenticates the fingerprint information entered by the user according to the fingerprint information stored in the Bluetooth financial IC card, turns on the Bluetooth financial IC card in the case that the fingerprint information entered by the user is authenticated successfully; otherwise, ends the method.

Preferably, Step 13 specifically is that the Bluetooth financial IC card calculates to obtain a fourth fingerprint eigenvalue according to the fingerprint information entered by the user, determines whether the fourth fingerprint eigenvalue is equal to the fingerprint information stored in the Bluetooth financial IC card, if yes, the fingerprint information entered by the user is authenticated successfully and the Bluetooth financial IC card stores the fourth fingerprint eigenvalue; otherwise, the fingerprint information entered by the user is authenticated unsuccessfully;

Correspondingly, in Step S2, in the case that the card-holder authenticated method chosen by the Bluetooth financial IC card is the on-line fingerprint authenticated type, said executing the card-holder authenticated operation according to the chosen card-holder authenticated method specifically is that the Bluetooth financial IC card encrypts the fourth fingerprint eigenvalue to obtain an encrypted fourth fingerprint eigenvalue; the on-line transaction message includes the encrypted fourth fingerprint eigenvalue.

Preferably, Step 13 specifically includes that the Bluetooth financial IC card calculates to obtain the fourth fingerprint eigenvalue according to the fingerprint information entered by the user, determines whether the fourth fingerprint eigenvalue is same as the fingerprint information stored by itself, if yes, the authentication is successful, information that turning on authenticated successfully is generated, and store the information that turning on authenticated successfully; otherwise, the authentication is unsuccessful;

Correspondingly, in Step S2, in the case that the card-holder authenticated method chosen by the Bluetooth financial IC card is the off-line fingerprint authenticated type, said executing the card-holder authenticated operation according to the chosen card-holder authenticated method specifically is that the Bluetooth financial IC card generates the successful off-line fingerprint authenticated result according to the stored turning-on authenticated successfully information; said on-line transaction message includes the successful off-line authenticated result and the on-line identifying code stored in the Bluetooth financial IC card; or, the on-line transaction message includes the successful off-line fingerprint authenticated result.

Preferably, Step 13 specifically is that the Bluetooth financial IC card calculates to obtain the fourth fingerprint eigenvalue, determines whether the fourth fingerprint eigenvalue is equal to the fingerprint information stored by itself, if yes, the authentication is successful, the information that turning on authenticated successfully is generated, and the information that turning on authenticated successfully is stored; otherwise, the authentication is unsuccessful;

Correspondingly, in Step S2, in the case that the card-holder authenticated method chosen by the Bluetooth financial IC card is the off-line fingerprint authenticated type, said executing the card-holder authenticated operation according to the chosen card-holder authenticated method specifically is the Bluetooth financial IC card generates the successful off-line fingerprint authenticated result according to the stored information that turning on authenticated successfully; said off-line transaction blog includes the successful off-line fingerprint authenticated result.

Or, the Bluetooth financial IC card executing the turning on authenticated operation specifically includes that

Step 21, the Bluetooth financial IC card prompts the user to enter a turning on identifying code;

Step 22, the Bluetooth financial IC card obtains the turning on identifying code entered by the user;

Step 23, the Bluetooth financial IC card authenticates the turning on identifying code entered by the user according to the turning on identifying code stored by the Bluetooth financial IC card, executes the turning on operation in the case that the turning on identifying code entered by the user is authenticated successfully; otherwise, ends the method.

Preferably, in the case that the authentication is successful, Step 23 further includes that the Bluetooth financial IC card generates the information that turning on authenticated successfully;

Correspondingly, in Step S2, in the case that the card-holder authenticated method chosen the Bluetooth financial IC card is the off-line identifying code authenticated type, said executing the card-holder authenticated operation specifically is that the Bluetooth financial IC card generates the successful off-line identifying code authenticated result according to the information that turning on authenticated successfully;

Said on-line transaction message includes the successful off-line identifying code authenticated successful result and the on-line identifying code stored in the Bluetooth financial IC card; or, the on-line transaction message includes the successful off-line identifying code authenticated result.

Preferably, in the case that the Bluetooth financial IC card authenticates the turning on identifying code successfully, Step 23 further includes that the Bluetooth financial IC card generates the information that turning on authenticated successfully;

Correspondingly, in Step S2, in the case that the card-holder authenticated method chosen by the Bluetooth financial IC card is the off-line identifying code authenticated type, said executing the card-holder authenticated operation according to the chosen card-holder authenticated method specifically is that the Bluetooth financial IC card generates the successful off-line identifying code authenticated result according to the information that turning on authenticated successfully;

Said off-line transaction blog includes the successful off-line identifying code authenticated result.

Preferably, said method further includes that the Bluetooth financial IC card ends the transaction, generates an ending transaction response, and sends the ending transaction response to the upper computer via Bluetooth in the case that the application cryptogram in the action analysis result is an application authenticating cryptogram.

Comparing with the prior, the advantages of Embodiment 1 is that the Bluetooth financial IC card includes both functions of a financial IC card and a transaction terminal in the present disclosure, it does not need to communicate with the transaction terminal in the transaction, thus, it is more convenient and makes the work more efficient and lower the cost. Meanwhile, the transaction becomes more security when the fingerprint authenticated type is used. Moreover, Bluetooth financial IC card, integrating with functions of a financial IC card and a transaction terminal, is made by a single manufacturer. In this case, in the process of making the Bluetooth financial IC card, it is not necessary for any two manufacturers to do any cooperative work, thus preventing from any cost for coordinating activities between different product makers.

Furthermore, when any card holder performs an authenticating operation, an authenticating information, such as off-line authenticating code, fingerprint information or on-line authenticating code, is input on the Bluetooth financial IC card by the user, not on any device of a business company. Therefore, the authenticating information cannot be known by others, thus improving the information security of the card holder.

### Embodiment 2

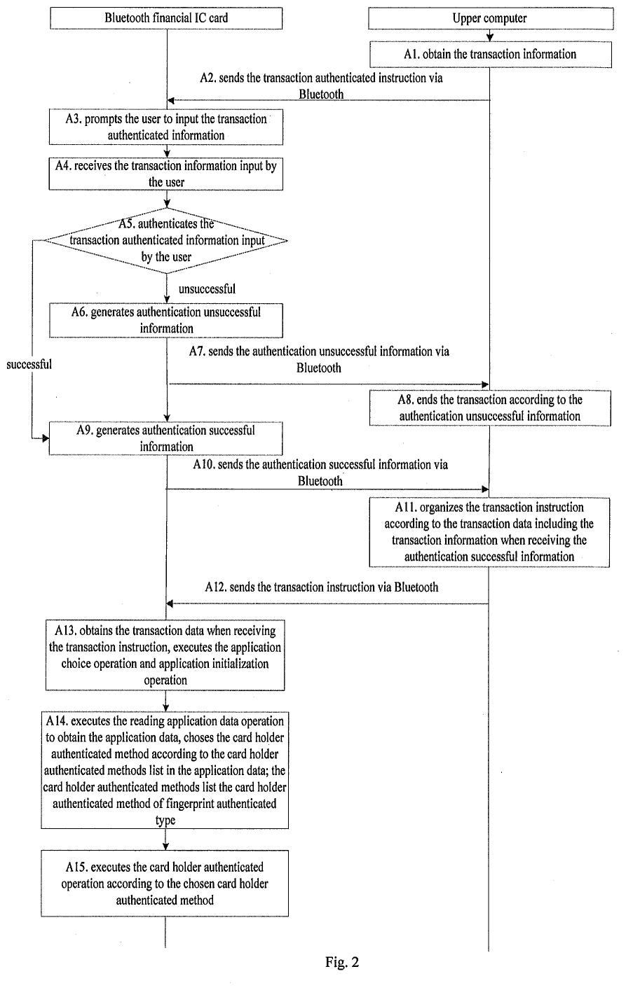

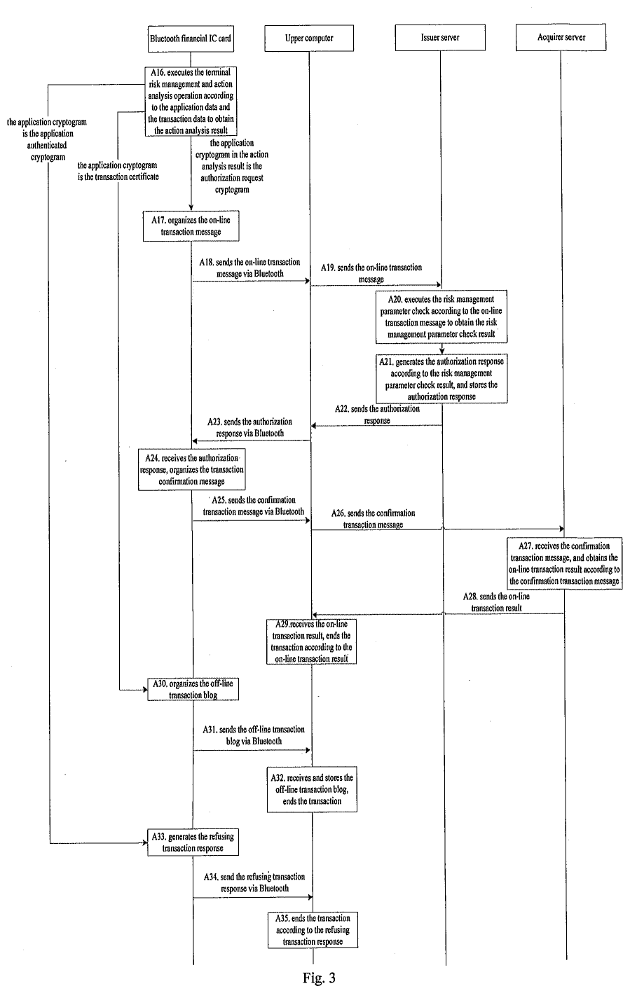

In Embodiment 2, it provides a working method for a system which includes a Bluetooth financial IC card, an upper computer, a card issuer server, and an acquirer bank server, as shown in FIG. 2 and FIG. 3, includes that

Step A1, the upper computer obtains transaction information.

Specifically, the transaction information includes transaction amount.

Specifically, the upper computer obtains transaction amount information when it scans bar code on a product; or, the upper computer obtains the transaction amount information when the user enters the transaction amount information into the upper computer and presses the enter key to confirm the operation.

Preferably, after the upper computer obtains the transaction amount information, the method further includes that the upper computer displays the transaction amount.

Step A2, the upper computer sends a transaction authenticated instruction to the Bluetooth financial IC card via Bluetooth.

Specifically, the transaction authenticated instruction specifically is a fingerprint authenticated instruction or an identifying authenticated instruction.

Preferably, before Step A2, the method further includes that

Step M1, the upper computer determines whether it builds a connection with the Bluetooth financial IC card via Bluetooth, if yes, goes to Step A2; otherwise, goes to Step M2;

Step M2, the upper computer builds a Bluetooth connection with the Bluetooth financial IC card;

Step M2 further includes that the Bluetooth financial IC card executes data broadcasting.

For instance, the data broadcasted by the Bluetooth financial IC card specifically is 11 09 46 54 5F 32 30 30 30 30 30 30 30 30 30 31 32 00 02 01 05 11 07 45 46 41 53 54 46 00 00 C3 00 01 00 01 00 54 46, in which, data on bytes from the third byte to the eighteenth byte means a name of the Bluetooth financial IC card. The upper computer stores the name of the Bluetooth financial IC card which connected with it after the Bluetooth connection is built.

Step A3, the Bluetooth financial IC card prompts a user to enter transaction authenticated information.

Step A4, the Bluetooth financial IC card receives the transaction authenticated information entered by the user.

Step A5, the Bluetooth financial IC card authenticates the transaction authenticated information entered by the user, goes to Step A6 in the case that the transaction authenticated information is authenticated unsuccessfully; goes to Step A9 in the case that the transaction authenticated information is authenticated successfully.

Step A6, the Bluetooth financial IC card generates information that the transaction authenticated information is authenticated unsuccessfully.

Step A7, the Bluetooth sends the information that the transaction authenticated information is authenticated unsuccessfully to the upper computer via Bluetooth.

Step A8, the upper computer ends the transaction according to the information that the transaction authenticated information is authenticated unsuccessfully.

Step A9, the Bluetooth financial IC card generates information that the transaction authenticated information is authenticated successfully.

Step A10, the Bluetooth financial IC card sends the information that the transaction authenticated information is authenticated successfully to the upper computer via Bluetooth.

The Bluetooth financial IC card takes part in the transaction executed by the system which includes the Bluetooth financial IC card, the upper computer, the card issuer server, and the acquirer server after it sends the information that the transaction authenticated information is authenticated successfully to the upper computer via Bluetooth, as shown in FIG. 2 and FIG. 3, after Step A10, the method further includes that.

Step A11, the upper computer organizes a transaction instruction according to the transaction data which includes the transaction information when the upper computer receives the information that the transaction authenticated information is authenticated successfully.

Specifically, the transaction data includes a transaction type, the transaction information, a transaction date, and a transaction time.

For instance, the transaction instruction organized by the upper computer according to the transaction type 41, the transaction amount 1.00, the transaction date Mar. 11, 2016, the transaction time 14:57:36 is 7e 41 00 00 14 00 00 00 00 01 00 16 03 11 14 57 36.

Furthermore, the transaction data further includes information, such as a vendor name.

Step A12, the upper computer sends the transaction instruction to the Bluetooth financial IC card via Bluetooth.

Step A13, the Bluetooth financial IC card receives the transaction instruction, obtains the transaction data from the transaction instruction, and executes application chosen operation and application initialized operation.

For instance, in the case that the transaction instruction obtained by the Bluetooth financial IC card is 7e 41 00 00 14 00 00 00 00 01 00 16 03 11 14 57 36, the second byte of the transaction instruction, which is 41, is the transaction type, 41 means a consumption transaction; data on the bytes from the sixth byte to the eleventh byte, which is 00 00 00 00 01 00, is the transaction amount, 00 00 00 00 01 00 means the transaction amount is 1.00 rmb; data on the bytes from the twelfth byte to the fourteenth byte, which is 16 03 11, is the transaction date, which means Mar. 11, 2016; the data on the bytes from the fifth byte to the seventeenth byte, which is 14 57 36, is the transaction time, which means 14:57:36.

Step A14, the Bluetooth financial IC card executes a reading application data operation to obtain the application data, chooses the card-holder authenticated method according to a card holder authenticated method list in the application data; the card holder authenticated method list includes the card holder authenticated method which belongs to the fingerprint authenticated type.

In the disclosure, the card holder authenticated method which belongs to the fingerprint authenticated type in the card holder authenticated method list specifically includes card holder authenticated method of off-line fingerprint authenticated type and/or the card holder authenticated method of the on-line fingerprint authenticated type.

Furthermore, the types of the card holder authenticated method in the card holder authenticated method list can also include signature, without card holder authenticating, signature and off-line plaintext identifying code authenticated composition, and one or multiple of certificates of the card holder.

Step A15, the Bluetooth financial IC card executes the card holder authenticated operation according to the chosen card holder authenticated method.

Preferably, in Embodiment 2, in the case that the card holder authenticated method chosen by the Bluetooth financial IC card is the off-line identifying code authenticated type or the off-line fingerprint authenticated type in Step A14 and the off-line authenticating result obtained in Step A15 is failure, the method further includes that the Bluetooth financial IC card chooses the next card holder authenticated method from the card holder authenticated method list, and executes the card holder authenticated operation.

Step A16, the Bluetooth financial IC card executes terminal risk management and action analysis according to the application data and the transaction data to obtain the action analysis result, and goes to Step A17 in the case that the application cryptogram in the action analysis result is an authorization request cryptogram; goes to Step A30 in the case that the application cryptogram in the action analysis result is a transaction certificate; goes to Step A33 in the case that the application cryptogram in the action analysis result is the application authentication cryptogram.

In Embodiment 2, in the process of off-line data authenticated operation, the Bluetooth financial IC card sets an off-line data abnormal flag in the case that the off-line data is authenticated unsuccessfully; in the process of risk management operation, the Bluetooth financial IC card sets a corresponding abnormal flag in the case that the risk management is abnormal.

In Embodiment 2, the action analysis executed by the Bluetooth financial IC card can includes the terminal action analysis operation and the card action analysis operation, and the action analysis result obtained includes the application cryptogram. The type of the application cryptogram can be the application authenticated cryptogram, the transaction certificate or the authentication request cryptogram.

Step A17, the Bluetooth financial IC card organizes the on-line transaction message.

Specifically, Step A17 specifically is that the Bluetooth financial IC card organizes the on-line transaction message according to the off-line data authenticated operation, the card holder authenticated operation, the terminal risk management operation, the action analysis result, the application data and the transaction data.

Preferably, Step A14 further includes that the Bluetooth financial IC card executes the off-line data authenticated operation according to the application data. Correspondingly, the on-line transaction message in Step A17 can also include relevant information of the off-line data authenticated.

Preferably, in the case that the card holder authenticated method chosen by the Bluetooth financial IC card is the off-line identifying code authenticated type, Step A15 specifically includes that

Step c11, the Bluetooth financial IC card prompts the user to enter an off-line identifying code;

Step c12, the Bluetooth financial IC card obtains the off-line identifying code entered by the user;

Step c13, the Bluetooth financial IC card authenticates the off-line identifying code entered by the user according to the off-line identifying code stored by itself, and generates the off-line identifying code authenticated result.

Preferably, in the case that the card holder authenticated method chosen by the Bluetooth financial IC card in the Step A14 is the off-line fingerprint authenticated type, Step A15 specifically includes that

Step d11, the Bluetooth financial IC card prompts the user to enter fingerprint information;

Step d12, the Bluetooth financial IC card obtains the fingerprint information entered by the user; and

Step d13, the Bluetooth financial IC card authenticates the fingerprint information entered by the user according to the fingerprint information stored by itself, and generates the off-line fingerprint authenticated result.

Specifically, Step d13 is that the Bluetooth financial IC card determines whether the fingerprint information stored by itself matches with the fingerprint information entered by the user, if yes, generates the successful off-line fingerprint authenticated result; otherwise, generates the unsuccessful off-line fingerprint authenticated result.

Furthermore, in the case that the Bluetooth financial IC card determines that the fingerprint information stored by itself does not match with the fingerprint information entered by the user, before the unsuccessful off-line fingerprint authenticated result is generated, Step d13 further includes that the Bluetooth financial IC card updates a frequency of fingerprint information authenticated, determines whether the frequency of the fingerprint information authenticated is less than a preset frequency, if yes, returns to Step d11; otherwise, generates the unsuccessful off-line fingerprint authenticated result. For instance, the preset frequency is 3.

Correspondingly, in the case that the off-line fingerprint authenticated result is the successful off-line fingerprint authenticated result, the off-line transaction message includes that the off-line fingerprint authenticated result, and the on-line identifying code stored by the Bluetooth financial IC card;

In the case that the off-line fingerprint authenticated result is the unsuccessful fingerprint authenticated result, the on-line transaction message includes the unsuccessful off-line fingerprint authenticated result.

Preferably, in the case that the card holder authenticated method chosen by the Bluetooth financial IC card is the on-line fingerprint authenticated type, Step A15 specifically includes

Step e11, the Bluetooth financial IC card prompts the user to enter the fingerprint information;

Step e12, the Bluetooth financial IC card obtains the fingerprint information entered by the user; and

Step e13, the Bluetooth generates the third fingerprint eigenvalue according to obtained fingerprint information, encrypts the third fingerprint eigenvalue to obtain the encrypted third fingerprint eigenvalue.

Correspondingly, in Step A17, the on-line transaction message organized by the Bluetooth financial IC card includes the encrypted third fingerprint eigenvalue.

Preferably, in the case that the card holder authenticated method chosen by the Bluetooth financial IC card is the on-line identifying code authenticated type, Step A15 specifically includes that

Step f11, the Bluetooth financial IC card prompts the user to enter the on-line identifying code;

Step f12, the Bluetooth financial IC card obtains the on-line identifying code entered by the user; and

Step f13, the Bluetooth financial IC card encrypts the on-line identifying code entered to obtain the encrypted on-line identifying code;

Correspondingly, the on-line transaction message organized by the Bluetooth financial IC card in Step A17 includes the encrypted on-line identifying code.

Step A18, the Bluetooth financial IC card sends the on-line transaction message to the upper computer via Bluetooth.

Step A19, the upper computer sends the on-line transaction message to the card issuer server.

Step A20, the card issuer server executes risk management parameter check according to the on-line transaction message to obtain a risk management parameter check result.

In Embodiment 2, Step A20 can specifically is that the card issuer server checks parameters, such as the transaction data in the on-line transaction message, the off-line data authenticated result, the card holder authenticated result, the terminal risk management result, the action analysis result, to obtain the risk management parameter check result.

Furthermore, in the case that the on-line transaction message obtained by the card issuer server includes the encrypted third fingerprint eigenvalue in Step A20, Step A20 further includes that the card issuer server decrypts the encrypted third fingerprint eigenvalue to obtain the third fingerprint eigenvalue, determines whether the third fingerprint eigenvalue matches with the fingerprint eigenvalue stored by itself, if yes, the fingerprint authenticated in the risk management result is passed; otherwise, the fingerprint authenticated is not passed.

In the case that the on-line transaction message obtained by the card issuer server includes the encrypted on-line identifying code, Step A20 further includes that the card issuer server decrypts the encrypted on-line identifying code to obtain the on-line identifying code, determines that on-line identifying code is equal to the on-line identifying code stored by itself, if yes, the on-line authenticated in the risk management result is passed; otherwise, the on-line authenticated in the risk management result is not passed.

Preferably, the on-line transaction message organized by the Bluetooth financial IC card in Step A17 further includes an account number of the Bluetooth financial IC card and an account balance; correspondingly, Step A20 further includes that the card issuer server determines whether a transaction amount is less than the account balance, if yes, a transaction amount limit in the risk management result is authenticated successfully; otherwise, the transaction amount limit in the risk management result is authenticated unsuccessfully.

Step A21, the card issuer server generates an authorization response according to the risk management parameter check result, and stores the authorization response.

Specifically, Step A21 is that the card issuer server generates an authorization response code according to the risk management parameter check result, and generates the authorization response according to the authorization response code, the risk management result and the transaction data.

For instance, the card issuer server organizes the authorization response 8A0230309F02060000000001009 A1603119F21114650 according to the authorization response code 8A023030, which means successful, and the transaction amount 9F0206000000000100 which means RMB1.00.

Preferably, after Step A21, the method further includes that the card issuer server updates the account balance of a current account according to the transaction amount in the case that the risk management parameter check result is pass; correspondingly, the authorization response further includes an updated account balance.

Step A22, the card issuer server sends the authorization response to the upper computer.

Step A23, the upper computer sends the authorization response to the Bluetooth financial IC card via Bluetooth.

Step A24, the Bluetooth financial IC card receives the authorization response, and organizes a transaction confirmation message.

Preferably, Step A24 can specifically be that the Bluetooth financial IC card receives the authorization response, and organizes the transaction confirmation message according to the authorization response, the application data, the transaction data, the card holder authenticated operation, the off-line data authenticated operation, the terminal risk management operation and the action analysis result.

For instance, the authorization response received by the Bluetooth financial IC card is 8A0230309F020600 00000001009A1603119F21114650, 8A023030 is obtained as the authorization response code, 3030 is made as a successful authorization response code identifier; 9F0206000000000100 is obtained as the transaction amount identifier, and 000000000100 is obtained as a transaction amount identifier of RMB1.00.

Step A25, the Bluetooth financial IC card sends the confirmation transaction message to the upper computer via Bluetooth.

Step A26, the upper computer sends the confirmation transaction message to the acquirer server.

Step A27, the acquirer server receives the confirmation transaction message, and to obtains the on-line transaction result according to the confirmation transaction message.

Step A28, the acquirer server sends the on-line transaction result to the upper computer.

Step A29, the upper computer ends the transaction according to the on-line transaction result in the case that the upper computer receives the on-line transaction result.

Preferably, Step A22 further includes that the card issuer server sends card issuer authenticated data to the upper computer;

Correspondingly, Step A23 further includes that the upper computer sends the card issuer authenticated data to the Bluetooth financial IC card via Bluetooth;

Step A24 further includes that the Bluetooth financial IC card executes card issuer authenticated operation according to the card issuer data; said transaction confirmation message further includes the card issuer authenticated result.

Step A30, the Bluetooth financial IC card organizes the off-line transaction blog.

Preferably, Step A30 can specifically be that the Bluetooth financial IC card organizes the off-line transaction blog according to the off-line data authenticated operation, the card holder authenticated operation, the terminal risk management operation, the action analysis result, the application data and the transaction data.

Step A31, the Bluetooth financial IC card sends the off-line transaction blog to the upper computer via Bluetooth.

Step A32, the upper computer receives the off-line transaction blog, and stores the off-line transaction blog, and ends the transaction.

Preferably, steps from Step A30 to Step A32 can be replaced as that the Bluetooth financial IC card organizes the off-line transaction blog, and stores the off-line transaction blog, and returns transaction successful information to the upper computer, and the upper computer ends the transaction according to the transaction successful information.

Step A33, the Bluetooth financial IC card generates a transaction refused response.

Step A34, the Bluetooth financial IC card sends the transaction refused response to the upper computer via Bluetooth.

Step A35, the upper computer ends the transaction according to the transaction refused response.

Preferably, in the case that the card holder authenticated method chosen by the Bluetooth financial IC card is the off-line identifying code authenticated type in Step A14, Step A15 specifically includes that

Step c21, the Bluetooth financial IC card prompts the user to enter the off-line identifying code;

Step c22, the Bluetooth financial IC card obtains the identifying code entered by the user; and

Step c23, the Bluetooth financial IC card authenticates the off-line identifying code entered by the user according to the off-line identifying code stored by itself, and generates the off-line identifying code authenticated result.

Specifically, Step c23 is that the Bluetooth financial IC card determines whether the obtained off-line identifying code is same as the off-line identifying code stored by itself, if yes, generates the successful off-line identifying code authenticated result; otherwise, generates the failure off-line identifying code authenticated result.

Correspondingly, in Step A30, the off-line transaction blog organized by the Bluetooth financial IC card includes the off-line identifying code authenticated result.

Furthermore, in the case that the Bluetooth financial IC card determines the obtained off-line identifying code is different from the off-line identifying code stored by itself, before generating the failure off-line identifying code authenticated result, Step c23 further includes that the Bluetooth financial IC card updates the number of times of authenticating the off-line identifying code, and determines whether the updated number of times of authenticating the off-line identifying code is less than the preset number of times, if yes, returns to Step c21; otherwise, generates the failure off-line identifying code authenticated result. For instance, the preset number of times is 3 times.

Preferably, in the case that the card holder authenticated method chosen by the Bluetooth financial IC card is the off-line fingerprint authenticated type in the Step A14, Step A15 specifically includes that

Step m11, the Bluetooth financial IC card prompts the user to enter the fingerprint information;

Step m12, the Bluetooth financial IC card obtains the fingerprint information entered by the user; and

Step m13, the Bluetooth financial IC card authenticated the fingerprint information according to the fingerprint information stored by itself, and generates the off-line fingerprint authenticated result.

Specifically, Step m13 specifically is that the Bluetooth financial IC card determines whether the fingerprint information stored by itself matches with the fingerprint information entered by the user, if yes, generates the successful off-line fingerprint authenticated result; otherwise, generates the failure off-line fingerprint authenticated result.

Correspondingly, in Step A30, the off-line transaction blog organized by the Bluetooth financial IC card includes the off-line fingerprint authenticated result.

Furthermore, in the case that the Bluetooth financial IC card determines the fingerprint information stored by itself does not match with the fingerprint information entered by the user in Step m13, before generating the failure off-line fingerprint authenticated result, Step m13 further includes that the Bluetooth financial IC card updates the number of times of off-line fingerprint authenticating, and determines whether the updated number of times is less than the preset number of times, if yes, returns to Step m11; otherwise, generates the failure off-line fingerprint authenticated result. For instance, the preset number of times is 3.

Preferably, steps from Step A3 to Step A5 specifically is that

Step S01, the Bluetooth financial IC card receives the fingerprint authenticated instruction from the upper computer, and prompts the user to enter the fingerprint information;

Step S02, the Bluetooth financial IC card receives the fingerprint information entered by the user; and

Step S03, the Bluetooth financial IC card authenticated the fingerprint information entered by the user according to the fingerprint information stored by itself, goes to Step A6 if the authentication is unsuccessful; goes to Step A9 if the authentication is successful.

Correspondingly, in the case that the card holder authenticated method chosen by the Bluetooth financial IC card is the on-line fingerprint authenticated type in Step A14, Step A15 can specifically be that the Bluetooth financial IC card generates the third fingerprint eigenvalue according to the fingerprint information entered by the user, encrypts the third fingerprint eigenvalue to obtain the encrypted third fingerprint eigenvalue; the on-line transaction message organized by the Bluetooth financial IC card in Step A17 includes the third fingerprint eigenvalue.

Or, correspondingly, in the case that the card holder authenticated method chosen by the Bluetooth financial IC card is the off-line fingerprint authenticated type in Step A14, Step A15 can specifically be that the Bluetooth financial IC card generates the successful off-line fingerprint authenticated result according to the information that authenticating is successful; correspondingly, in said Step A17, the on-line transaction message organized by the Bluetooth financial IC card includes the successful off-line fingerprint authenticated result and the on-line identifying code stored in the Bluetooth financial IC card; or, the on-line transaction message includes the successful off-line fingerprint authenticated result.

Or, correspondingly, in the case that the card holder authenticated method chosen by the Bluetooth financial IC card is the off-line fingerprint authenticated type in Step A14, Step A15 can specifically be that the Bluetooth financial IC card generates the successful off-line fingerprint authenticated result according to the information that authenticating is successful; correspondingly, in Step A30, off-line transaction blog organized by the Bluetooth financial IC card includes the successful off-line fingerprint authenticated result.

Preferably, steps from Step A3 to Step A5 can specifically include that

Step L01, the Bluetooth financial IC card receives an authenticating identifying code instruction from the upper computer, prompts the user to enter the identifying code;

Step L02, the Bluetooth financial IC card obtains the identifying code entered by the user; and

Step L03, the Bluetooth financial IC card authenticates the identifying code entered by the user according to the identifying code stored by itself, goes to Step A6 if the authentication is unsuccessful; goes to Step A9 if the authentication is successful.

Correspondingly, in the case that the card holder authenticated method chosen by the Bluetooth financial IC card is the off-line identifying code authenticated type in Step A14, Step A15 specifically is that the Bluetooth financial IC card generates the successful off-line identifying code authenticated result according to the information that the authentication is successful; in Step A17, the on-line transaction message organized by the Bluetooth financial IC card includes the successful off-line identifying code authenticated result and on-line identifying code stored in the Bluetooth financial IC card; or, the on-line transaction message includes the successful off-line identifying code authenticated result.

Or, correspondingly, in the case that the card holder authenticated method chosen by the Bluetooth financial IC card is the off-line identifying code authenticated type, Step A15 specifically is that the Bluetooth financial IC card generates the successful off-line identifying code authenticated result according to the information that the authentication is successful; the off-line transaction blog organized by the Bluetooth financial IC card in Step A30 includes the successful off-line identifying code authenticated result.

In Embodiment 2, when the card holder is authenticated, the user enters identifying information in the Bluetooth financial IC card (the fingerprint information entered by the user or the identifying code entered by the user), the authentication information is not sent in the process of information interaction between the Bluetooth financial IC card and the upper computer, meanwhile, before the transaction and when authenticating the transaction, the transaction authenticated information is entered in the Bluetooth financial IC card, in this way, the authentication information and the transaction information become safer. In Embodiment 2, it provides a double protection with transaction authenticated and card holder authenticated to make the transaction more security.

In Embodiment 2, before Step A3, the method further includes that the Bluetooth financial IC card executes turning on authenticated operation before turning on the Bluetooth financial IC card. Specifically, the Bluetooth financial IC card executes turning on authenticated operation when receiving a turning on event entered by the user. For instance, the Bluetooth financial IC card receives the turning on event when the user presses the turning on key.

Preferably, the Bluetooth financial IC card executing the turning on operation specifically includes that

Step 11, the Bluetooth financial IC card prompts the user to enter fingerprint information;

Step 12, the Bluetooth financial IC card obtains the fingerprint information entered by the user; and

Step 13, the Bluetooth financial IC card authenticates the fingerprint information entered by the user according to the fingerprint information stored by itself, turns on the Bluetooth financial IC card if the authentication is successful; otherwise, ends the method. Specifically, Step 13 is that the Bluetooth financial IC card determines whether the fingerprint information stored by itself matches with the fingerprint information entered by the user, if yes, the authentication is successful; otherwise, the authentication is unsuccessful.

Furthermore, in the case that the Bluetooth financial IC card determines that the fingerprint information entered by the user does not match with the fingerprint information stored by itself, Step 13 further includes that the Bluetooth financial IC card updates the number of times of authenticating fingerprint information, determines whether the updated number of times of authenticating fingerprint information is less than the preset number of times, if yes, returns to Step 11; otherwise, the authentication is unsuccessful, ends the method. For instance, the preset number of times is 3.

Preferably, the Bluetooth financial IC card executing the turning on authenticated operation can specifically include that

Step 21, the Bluetooth financial IC card prompts the user to enter a turning on identifying code;

Step 22, the Bluetooth financial IC card obtains the turning on identifying code entered by the user; and

Step 23, the Bluetooth financial IC card authenticates the turning on identifying code entered by the user according to the turning on identifying code stored by itself, turning on the Bluetooth financial IC card if the authentication is successful; otherwise, ends the method.

Specifically, Step 23 specifically is that the Bluetooth financial IC card determines whether the turning on identifying code obtained is just the same as the turning on identifying code stored by itself, if yes, the authentication is successful; otherwise, the authentication is unsuccessful, and ends the method. Furthermore, in the case that the Bluetooth financial IC card determines that the turning on identifying code obtained is different from the turning on identifying code stored by itself, Step 23 further includes that the Bluetooth financial IC card updates the number of times of turning on identifying code operation, and determines whether the updated number of times of turning on identifying code authenticated operation is less than the preset number of times, if yes, returns to Step 21; otherwise, authentication is unsuccessful, the method is ended. For instance, the preset number of times is 3.

In Embodiment 2, the Bluetooth financial IC card includes a fingerprint input area, a user input the fingerprint in the fingerprint input area, and the Bluetooth financial IC card obtains the fingerprint input by the user.

In Embodiment 2, the way that the Bluetooth financial IC card prompts the user to input the fingerprint information, the turning on identifying code, the transaction identifying code, the off-line identifying code and the on-line identifying code specifically is that the Bluetooth financial IC card prompts the user via one way of multiple ways of displaying, voice or indicator lamp. For instance, the Bluetooth financial IC card prompts via voice or displays on the displaying screen that please input fingerprint.

In Embodiment 2, the Bluetooth financial IC card authenticating the fingerprint information input by the user according to the fingerprint information stored by itself specifically is that the Bluetooth financial IC card obtains the fingerprint eigenvalue stored by itself, calculates to obtain the third fingerprint eigenvalue according to the fingerprint information input by the user, and determines whether the third fingerprint eigenvalue matches with the fingerprint eigenvalue stored by itself.

Furthermore, the Bluetooth financial IC card determines that the third fingerprint eigenvalue does not match with the fingerprint eigenvalue stored by itself, the method further includes that the Bluetooth financial IC card updates the number of times of authenticating fingerprint information, determines whether the updated number of times of authenticating fingerprint information is less than the preset number of times, if yes, prompts the user to input fingerprint, and authenticates the fingerprint information input by the user; otherwise, the authentication is unsuccessful.

Specifically, the Bluetooth financial IC card calculating to obtain the third fingerprint eigenvalue according to the fingerprint information input by the user specifically is that the Bluetooth financial IC card calculates to obtain the third fingerprint eigenvalue according to a pattern of the obtained fingerprint information of the user.

Specifically, the Bluetooth financial IC card obtaining the fingerprint eigenvalue stored by itself specifically is that the Bluetooth financial IC card invokes the fingerprint eigenvalue stored in the fingerprints database of itself.

In Embodiment 2, in the case that the Bluetooth financial IC card stores multiple of fingerprint eigenvalues, the Bluetooth financial IC card determines whether there exists a fingerprint eigenvalue matching with the third fingerprint eigenvalue, if yes, authentication is successful; otherwise, the authentication is unsuccessful.

In Embodiment 2, the Bluetooth financial IC card executes the card holder authenticated operation, the turning on authenticated operation, the transaction authenticated operation by the way that a user input fingerprint information, thus there is no fingerprint information transmission between the Bluetooth financial IC card and the upper computer, in this way, the fingerprint information cannot be leaked; on the other side, a fingerprint is different from each other, which makes the transaction more security. Meanwhile, a user does not need to remember identifying code, such as a transaction identifying code or a turning identifying code when the card holder authenticated operation, the transaction authenticated operation and the turning on authenticated operation are executed via the fingerprint information, the method makes transactions more convenient.

Besides, in Embodiment 2, the turning on authenticated operation before turning on the Bluetooth financial IC card, and the transaction authenticated operation before transactions makes the transaction safer.

### Embodiment 3

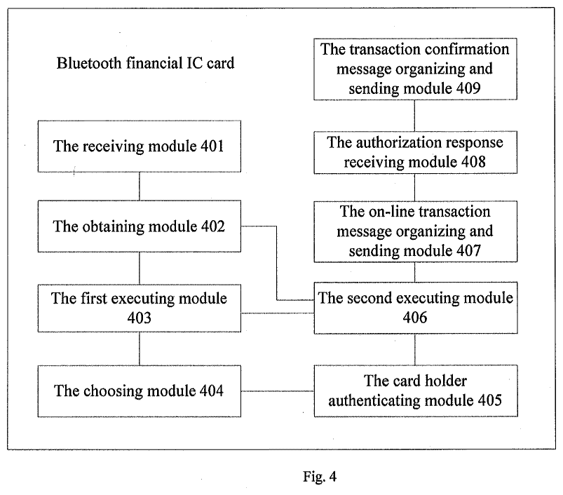

It provides a Bluetooth financial IC card according to Embodiment 3, as shown in FIG. 4, including that

a receiving module 401, which is configured to receive a transaction instruction from an upper computer via Bluetooth;

an obtaining module 402, which is configured to obtain transaction data from the transaction instruction received by the receiving module 401;

a first executing module 403, which is configured to execute an application choice, an application initialization, and reading application data to obtain application data after the obtaining module 402 obtains the transaction data;

a choosing module 404, which is configured to choose a card holder authenticated method according to a card holder authenticated method list in the application data obtained by the first executing module 403; the card holder authenticated method list includes a card holder authenticated method of fingerprint authenticated type;

the authenticating card holder module 405, which is configured to execute the card holder authenticated operation according to the card holder authenticated method chosen by the choosing module 404;

a second executing module 406, which is configured to execute a terminal risk management and execute an action analysis according to the application data obtained by the first executing module 403 and the transaction data obtained by the obtaining module 402 after the authenticating card holder module 405 executes the card holder authenticated operation according to the card holder authenticated method chosen by the choosing module 404;

an organizing and sending on-line transaction message module 407, which is configured to organize an on-line transaction message, and to send the on-line transaction message to the upper computer via Bluetooth in the case that an application cryptogram in a result of action analysis executed by the second executing module 406 is an authorization request cryptogram;

an authorization response receiving module 408, which is configured to receive an authorization response via Bluetooth after the on-line transaction message organizing and sending module 407 sends the on-line transaction message to the upper computer via the Bluetooth; and

a transaction confirmation message organizing and sending module 409, which is configured to organize the transaction confirmation message and send the transaction confirmation message to the upper computer via Bluetooth after the authorization response receiving module 408 receives the authorization response.

Preferably, the Bluetooth financial IC card further includes an off-line transaction blog organizing module;

the off-line transaction blog organizing module is configured to organize the off-line transaction blog in the case that the application cryptogram in the result of the action analysis executed by the second executing module 406 is the transaction certificate;

the Bluetooth financial IC card further includes an off-line transaction blog sending module or an off-line transaction blog storing module;

the off-line transaction blog sending module is configured to send the off-line transaction blog organized by the off-line transaction organizing module to the upper computer via Bluetooth; and

the off-line transaction blog storing module is configured to store the off-line transaction blog organized by the off-line transaction blog organizing module.

Preferably, the Bluetooth financial IC card further includes a transaction authenticating module;

the transaction authenticating module is configured to receive a transaction authenticating instruction from the upper computer, to prompt a user to authenticate the transaction according to the transaction authenticating instruction, to authenticate transaction authenticating information input by the user after the transaction authenticating information input by the user is received, and to return an authentication successful response to the upper computer if the authentication is successful; otherwise, return an authentication unsuccessful response to the upper computer if the authentication is unsuccessful.

In Embodiment 3, the Bluetooth financial IC card further includes a storing module;

the storing module is configured to store fingerprint information;

the transaction authenticating module specifically includes that

a first receiving sub module, which is configured to receive a fingerprint authenticated instruction from the upper computer;

a first prompting sub module, which is configured to prompt a user to input fingerprint information after the first receiving sub module receives the fingerprint authenticated instruction from the upper computer;

a fingerprint information receiving sub module, which is configured to receive the fingerprint information input by the user;

a fingerprint authenticating sub module, which is configured to authenticate the fingerprint information input by the user received by the fingerprint information receiving sub module according to the fingerprint information stored by the storing module, generate information that the authentication is successful if the authentication is successful, and return the information that the authentication is successful to the upper computer; otherwise, generate information that the authentication is unsuccessful, and return the information that the authentication is unsuccessful to the upper computer.

Specifically, said card holder authenticating module 405 is specifically configured to generate the third fingerprint eigenvalue according to the fingerprint information input by the user received by the fingerprint information receiving sub module, to encrypt the third fingerprint eigenvalue to obtain an encrypted third fingerprint eigenvalue in the case that the card holder authenticated method chosen by the choosing module 404 is the on-line fingerprint authenticated type.

Correspondingly, the on-line transaction message organized by the on-line transaction message organizing and sending module 407 includes the encrypted third fingerprint eigenvalue obtained by the card holder authenticating module 405.

Or, specifically, the card holder authenticating module 405 is specifically configured to generate a successful off-line authenticating result according to the authentication successful information generated by the fingerprint authenticating sub module.

Correspondingly, said storing module is further configured to store the on-line identifying code;

Correspondingly, the on-line transaction message organized by the on-line transaction message organizing and sending module 407 includes the successful off-line fingerprint authenticated result generated by the card holder authenticating module 405 and the on-line identifying code stored by the storing module; or, the on-line transaction message organized by said on-line transaction message organizing and sending module 407 includes that the successful off-line fingerprint authenticated result generated by the card holder authenticating module 405.

Or, specifically, said card holder authenticating module 405 is specifically configured to generate the successful off-line fingerprint authenticated result according to the information that the authentication is successful generated by the fingerprint authenticating sub module in the case that the card holder authenticated method chosen by the choosing module 404 is the off-line fingerprint authenticated type.

Correspondingly, the off-line transaction blog organized by said off-line transaction blog organizing module includes the successful off-line fingerprint authenticated result generated by the card holder authenticating module 405.

In Embodiment 3, the Bluetooth financial IC card further includes the storing module on the basis of including the authenticating module;

the storing module is configured to store the transaction identifying code;

the transaction authenticating module specifically includes that

a second receiving sub module which is configured to receive an identifying code authenticated instruction from the upper computer;

a second prompting sub module which is configured to prompt the user to input a transaction identifying code after the second receiving sub module receives the fingerprint authenticated instruction;

an identifying code obtaining sub module which is configured to obtain a transaction identifying code input by the user; and

an identifying code authenticating sub module which is configured to authenticate the transaction identifying code which is obtained by the identifying code obtaining sub module from the user according to the transaction identifying code stored by the storing module, to generate the authentication successful information, and send the authentication successful information to the upper computer if the transaction identifying code is authenticated successfully; otherwise, to generate the authentication unsuccessful information, and send the authentication unsuccessful information to the upper computer.

Specifically, said card holder authenticating module 405 is specifically configured to generate the successful off-line identifying code authenticated result according to the authentication successful information generated by the identifying code authenticating sub module in the case that the card holder authenticated method chosen by the choosing module 404 is the off-line identifying code authenticated type;

said storing module is further configured to store the on-line identifying code;

correspondingly, the on-line transaction message organized by said on-line transaction message organizing and sending module 407 includes the successful off-line identifying code authenticated result generated by the card holder authenticating module 405 and the on-line identifying code stored by the storing module; or the on-line transaction message organized by the on-line transaction message organizing and sending module 407 includes that the successful off-line identifying code authenticated result generated by the card holder authenticating module 405.

Or, specifically, said card holder authenticating module 405 is specifically configured to generate the successful off-line identifying code authenticated result according to the authentication successful information generated by the identifying code sub module in the case that the card holder authenticated method chosen by the choosing module 404;

correspondingly, the off-line transaction blog organized by the off-line transaction blog organizing module includes the successful off-line fingerprint authenticated result generated by the card holder authenticating module 405.

Preferably, the Bluetooth financial IC card further includes a first storing module;

the first storing module is configured to store the off-line identifying code;

correspondingly, said card holder authenticating module 405 specifically includes that

a third prompting sub module which is configured to prompt the user to input the off-line identifying code in the case that the card holder authenticated method chosen by the choosing module 404 is the off-line identifying code authenticated type;

a third obtaining sub module which is configured to obtain the off-line identifying code input by the user;

a third authenticating sub module which is configured to authenticate the off-line identifying code obtained by the third obtaining sub module from the user according to the off-line identifying code stored by the first storing module, and to generate the off-line identifying code authenticated result.

Preferably, the Bluetooth financial IC card further includes a second storing module;

the second storing module is configured to store fingerprint information;

correspondingly, said card holder authenticating module 405 specifically includes that

a fourth prompting sub module which is configured to prompt the user to input the fingerprint in the case that the card holder authenticated method chosen by the choosing module 404 is the off-line fingerprint authenticated type;

a fourth obtaining sub module which is configured to obtain the fingerprint information input by the user;

a fourth authenticating sub module which is configured to authenticate the fingerprint information obtained by the fourth obtaining sub module according to the fingerprint information stored by the second storing module, and to generate the off-line fingerprint authenticated result.

Furthermore, the second storing module is further configured to store the on-line identifying code;

Correspondingly, the on-line transaction message organized by said on-line transaction message organizing and sending module 407 includes the successful off-line fingerprint authenticated result and the on-line identifying code stored by the second storing module in the case that the off-line fingerprint authenticated result generated by the fourth authenticating sub module is the successful off-line fingerprint authenticated result.

The on-line transaction message organized by the on-line transaction message organizing and sending module 407 includes the unsuccessful off-line fingerprint authenticated result in the case that the off-line fingerprint authenticated result generated by the fourth authenticating sub module is the unsuccessful off-line fingerprint authenticated result.

Preferably, said card holder authenticating module 405 can further includes that

a fifth prompting sub module which is configured to prompt the user to input fingerprint information in the case that the card holder authenticated method chosen by the choosing module 404 is the on-line fingerprint authenticated type;

a fifth obtaining sub module which is configured to obtain the fingerprint information input by the user;

a fingerprint feature generating sub module which is configured to generate the third fingerprint eigenvalue according to the fingerprint information obtained by the fifth obtaining sub module from the user, to encrypt the third fingerprint eigenvalue to obtain the encrypted third fingerprint eigenvalue;

correspondingly, the on-line transaction message organized by the on-line transaction message organizing and sending module 407 includes the encrypted third fingerprint eigenvalue obtained by the fingerprint feature generating sub module.

Preferably, said card holder authenticating module 405 can further include that

a sixth prompting sub module which is configured to prompt the user to input the on-line identifying code in the case that the card holder authenticated method chosen by the choosing module 404 is the on-line identifying code authenticated type;

a sixth obtaining sub module which is configured to obtain the user to input the on-line identifying code;

a sixth encrypting sub module which is configured to encrypt the on-line identifying code obtained by the sixth obtaining sub module from the user to obtain the encrypted on-line identifying code;

correspondingly, the on-line transaction message organized by said on-line transaction message organizing and sending module 407 includes the encrypted on-line identifying code obtained by the sixth encrypting sub module.

Preferably, the Bluetooth financial IC card further includes a turning on authenticating module;

the turning on authenticating module is configured to execute the turning on authenticated operation before the Bluetooth financial IC card turns on.

Furthermore, the Bluetooth financial IC card further includes a third storing module on the basis of including the turning on authenticating module;

the third storing module is configured to store fingerprint information;

said turning on authenticating module specifically includes that

a seventh prompting sub module which is configured to prompt the user to input the fingerprint information;

a seventh obtaining sub module which is configured to obtain the fingerprint information input by the user;

a seventh authenticating sub module which is configured to authenticate the fingerprint information obtained by the seventh obtaining sub module from the user according to the fingerprint information stored by the third storing module, turning on operation is executed if the authentication is successful; otherwise, the method is ended.

Specifically, said seventh authenticating sub module is specifically configured to calculate to obtain the fourth fingerprint eigenvalue according to the fingerprint information obtained by the seventh obtaining sub module from the user, to determine whether the fourth fingerprint eigenvalue is same as the fingerprint information stored in the third storing module, if yes, the authentication is successful and the fourth fingerprint eigenvalue is stored; otherwise, the authentication is unsuccessful;

correspondingly, said card holder authenticating module 405 is specifically configured to encrypt the fourth fingerprint eigenvalue stored by the seventh authenticating sub module to obtain the encrypted fourth fingerprint eigenvalue in the case that the card holder authenticated method chosen by the choosing module 404 is the on-line fingerprint authenticated type; the on-line transaction message organized by said on-line transaction message organizing and sending module 407 includes the encrypted fourth fingerprint eigenvalue obtained by the card holder authenticating module 405.

Or, said seventh authenticating sub module is specifically configured to calculate to obtain the fourth fingerprint eigenvalue according to the fingerprint information obtained by the seventh obtaining sub module from the user, to determine whether the fourth fingerprint eigenvalue is same as the fingerprint information stored by the third storing module, if yes, the authentication is successful, turning on authenticated successful information is generated and stored; otherwise, the authentication is unsuccessful;

correspondingly, said card holder authenticating module 405 is specifically configured to generate the successful off-line fingerprint authenticated result according to the turning on authenticated successful information stored by the seventh authenticated sub module in the case that the card holder authenticated method chosen by the choosing module 404 is the off-line fingerprint authenticated type;

said third storing module is further configured to store on-line identifying code, and the on-line transaction message organized by said on-line transaction message organizing and sending module 407 includes the successful off-line fingerprint authenticated result generated by the card holder authenticating module 405 and the on-line identifying code stored by the third storing module; or, the on-line transaction message organized by the on-line transaction message organizing and sending module 407 includes the successful off-line fingerprint authenticated result generated by the card holder authenticating module 405.

Or, the seventh authenticating sub module is specifically configured to calculate to obtain the fourth fingerprint eigenvalue according to the fingerprint information obtained by the seventh obtaining sub module from the user, to determine whether the fourth fingerprint eigenvalue is same as the fingerprint information stored by the third storing module, if yes, the authentication is successful, the turning on authenticated successful information is generated and stored; otherwise, the authentication is unsuccessful;

correspondingly, said card holder authenticating module 405 is specifically configured to generate the successful off-line fingerprint authenticated result according to the turning on authenticated successful information stored by the seventh authenticating sub module in the case that the card holder authenticated method chosen by the choosing module 404 is the off-line fingerprint authenticated type;

the off-line transaction blog organized by the off-line transaction blog organizing module includes the successful off-line fingerprint authenticated result generated by the card holder authenticating module 405.

Or, furthermore, the Bluetooth financial IC card includes a fourth storing module on the basis of including turning on authenticating module;

the fourth storing module is configured to store the turning on identifying code;

the turning on authenticating module specifically includes that

an eighth prompting sub module which is configured to prompt the user to input the turning on identifying code;

an eighth obtaining sub module which is configured to obtain the turning on identifying code input by the user;

an eighth authenticating sub module which is configured to authenticate the turning on identifying code obtained by the eighth obtaining sub module from the user according to the turning on identifying code stored by the fourth storing module, and to execute turning on operation is the authentication is successful; otherwise, the method is ended.

Preferably, the Bluetooth financial IC card further includes an ending transaction module;

the ending transaction module is configured to end the transaction, generate an ending transaction response, and send the ending transaction response to the upper computer via Bluetooth in the case that the application cryptogram in the action analysis result executed by the second executing module 406 is the application authenticated cryptogram.

In Embodiment 3, the first prompting sub module, the second prompting sub module, the third prompting sub module, the fourth prompting sub module, the fifth prompting sub module, the sixth prompting sub module, the seventh prompting sub module, the eighth prompting sub module can specifically be one type of multiple type of a voice prompting sub module, a displaying prompting sub module, or indicator lamp prompting sub module.

The technical solution in the Embodiments of the present invention is further described more clearly and completely with the drawings of the present invention. Apparently, Embodiments described herein are just a few Embodiments of the present invention. On the basis of Embodiments of the invention, all other related Embodiments made by those skilled in the art without any inventive work belong to the scope of the invention. Therefore, the scope of protection is defined by the claims attached herewith.

1. A working method for a Bluetooth financial IC card, wherein the method comprises the following steps:
S1) receiving, by the Bluetooth financial IC card, a transaction instruction from an upper computer via Bluetooth, and obtaining transaction data from the transaction instruction;
S2) executing, by the Bluetooth financial IC card, operations of an application selection, an application initialization, and data reading so as to obtain application data, and choosing a card holder authenticated method according to a card holder authenticated method list in the application data, executing a card holder authentication according to a card holder authenticated method, and the card holder authenticated method list includes the card holder authenticated method of fingerprint authenticated type;
S3) executing, by the Bluetooth financial IC card, a terminal risk management and an action analysis operation according to the application data and the transaction data, and executing Step S4 in the case that an application cryptogram in an action analysis result is an authorization request cryptogram;
S4) organizing, by the Bluetooth financial IC card, an on-line transaction message, and sending the on-line transaction message to the upper computer via Bluetooth; and
S5) receiving, by the Bluetooth financial IC card, an authorization response from the upper computer via Bluetooth, organizing a transaction confirmation message, and sending the transaction confirmation message to the upper computer via Bluetooth, then ending the method.

2. The method as claimed in claim 1, wherein said method further comprises that in the case that the application cryptogram in the action analysis result is a transaction certificate, the following operations are executed,
organizing, by the Bluetooth financial IC card, an off-line transaction blog, sending the off-line transaction blog to the upper computer via Bluetooth; or, organizing, by the Bluetooth financial IC card, an off-line transaction blog, and storing the off-line transaction blog.

3. The method as claimed in claim 2, wherein, before Step S1, said method further comprises:
S0) receiving, by the Bluetooth financial IC card, a transaction authenticated instruction from the upper computer, prompting the user to authenticate the transaction according to the transaction authenticated instruction, and authenticating the transaction authenticated information input by the use after the transaction authenticated information is received from the user, and returning an authentication successful response to the upper computer in the case that the authentication is successful; otherwise, returning an authentication unsuccessful response to the upper computer, and ending the transaction.

4. The method as claimed in claim 3, wherein, the step S0 specifically comprises that
S01) receiving, by the Bluetooth financial IC card, the transaction authenticated instruction from the upper computer, and prompting the user to input fingerprint information;
S02) receiving, by the Bluetooth financial IC card, the fingerprint information input by the user;
S03) authenticating, by the Bluetooth financial IC card, the fingerprint information input by the user according to fingerprint information stored by itself, generating the authentication successful information and returning the authentication successful information to the upper computer in the case that the authentication is successful; otherwise, generating the authentication unsuccessful information, and returning the authentication unsuccessful information to the upper computer, and ending the transaction.

5. The method as claimed in claim 4, wherein in the case that the card holder authenticated method chosen by the Bluetooth financial IC card is an on-line fingerprint authenticated type, executing the card holder authenticated operation according to the chosen card holder authenticated method in the step S2 specifically is that: generating, by the Bluetooth financial IC card, a third fingerprint eigenvalue according to the fingerprint information input by the user, and encrypting the third fingerprint eigenvalue so as to obtain an encrypted third fingerprint eigenvalue;
the on-line transaction message includes the encrypted third fingerprint eigenvalue.

6. The method as claimed in claim 4, wherein in the case that the card holder authenticated method chosen by the Bluetooth financial IC card is an off-line fingerprint authenticated type, the executing the card holder authenticated operation according to the chosen card holder authenticated method in the step S2 specifically is that: generating, by the Bluetooth financial IC card, a successful off-line fingerprint authenticated result according to the authentication successful information;
the on-line transaction message includes the successful off-line fingerprint authenticated result, an identifying code stored in the Bluetooth financial IC card; or, the on-line transaction message includes the successful off-line fingerprint authenticated result.

7. The method as claimed in claim 1, wherein in the case that the card holder authenticated method chosen by the Bluetooth financial IC card is the off-line identifying code authenticated type, the executing the card holder authenticated operation according to chosen card holder authenticated method in the step S2 specifically comprises the following steps:
c11) prompting, by the Bluetooth financial IC card, the user to input the off-line identifying code;
c12) obtaining, by the Bluetooth financial IC card, the off-line identifying code input by the user; and
c13) authenticating, by the Bluetooth financial IC card, the off-line identifying code input by the user according to the off-line identifying code stored by itself, and generating the off-line identifying code authenticated result.

8. The method as claimed in claim 1, wherein in the case that the card holder authenticated method chosen by the Bluetooth financial IC card is the off-line fingerprint authenticated type, the executing the card holder authenticated operation according to the chosen card holder authenticated method in the step S2 specifically comprises following steps:
d11) prompting, by the Bluetooth financial IC card, the user to input fingerprint information;
d12) obtaining, by the Bluetooth financial IC card, the fingerprint information input by the user; and
d13) authenticating, by the Bluetooth financial IC card, the fingerprint information input by the User according to the fingerprint information stored by itself, and generating the off-line fingerprint authenticated result.

9. The method as claimed in claim 1, wherein in the case that the card holder authenticated method chosen by the Bluetooth financial IC card is the on-line fingerprint authenticated type, the executing the card holder authenticated operation according to the card holder authenticated method chosen by the Bluetooth financial IC card in the step S2 specifically comprises the following steps:
e11) prompting, by the Bluetooth financial IC card, the user to input fingerprint information;
e12) obtaining, by the Bluetooth financial IC card, the fingerprint information input by the user; and
e13) generating, by the Bluetooth financial IC card, the third fingerprint eigenvalue according to the obtained fingerprint information, and encrypting the third fingerprint eigenvalue so as to obtain the encrypted third fingerprint eigenvalue;
the on-line transaction message includes the encrypted third fingerprint eigenvalue.

10. The method as claimed in claim 1, wherein in the case that the card holder authenticated method chosen by the Bluetooth financial IC card is the on-line identifying code authenticated type, said executing card holder authenticated operation according to the chosen card holder authenticated method specifically comprises following steps:
f11) prompting, by the Bluetooth financial IC card, the user to input an on-line identifying code;
f12) obtaining, by the Bluetooth financial IC card, the on-line identifying code input by the user; and
f13) encrypting, by the Bluetooth financial IC card, the on-line identifying code input by the user so as to obtain the encrypted on-line identifying code;
the on-line transaction message includes the encrypted on-line identifying code.

11. A Bluetooth financial IC card, wherein said card comprises:
a receiving module, which is configured to receive a transaction instruction from an upper computer via Bluetooth;
an obtaining module, which is configured to obtain transaction data from the transaction instruction received from the receiving module;
a first executing module, which is configured to execute an application choice operation, execute an application initialization, and execute reading application data to obtain application data after the obtaining module obtains the transaction data;
a choosing module, which is configured to choose a card holder authenticated method according to a card holder authenticated methods list in the application data obtained by the first executing module; the card holder authenticated methods list includes a card holder authenticated method of fingerprint authenticated type;
the card holder authenticating module, which is configured to execute the card holder authenticated operation according to the card holder authenticated method chosen by the choosing module;
a second executing module, which is configured to execute a terminal risk management and execute an action analysis operation according to the application data obtained by the first executing module and the transaction data obtained by the obtaining module after the card holder authenticating module executes the card holder authenticated operation according to the card holder authenticated method chosen by the choosing module;
an on-line transaction message organizing and sending module, which is configured to organize an on-line transaction message, and to send the on-line transaction message to the upper computer via Bluetooth in the case that an application cryptogram in a result of action analysis operation executed by the second executing module is an authorization request cryptogram;
an authorization response receiving module, which is configured to receive an authorization response via Bluetooth after the on-line transaction message organizing and sending module sends the on-line transaction message to the upper computer via the Bluetooth; and
a transaction confirmation message organizing and sending module, which is configured to organize the transaction confirmation message and send the transaction confirmation message to the upper computer via Bluetooth after the authorization response receiving module receives the authorization response.

12. The Bluetooth financial IC card as claimed in claim 11, wherein said card further comprises an off-line transaction blog organizing module;
the off-line transaction blog organizing module is configured to organize the off-line transaction blog in the case that the application cryptogram in the result of the action analysis operation executed by the second executing module is a transaction certificate;
the Bluetooth financial IC card further comprises an off-line transaction blog sending module or an off-line transaction blog storing module;
the off-line transaction blog sending module is configured to send the off-line transaction blog organized by the off-line transaction organizing module to the upper computer via Bluetooth; and
the off-line transaction blog storing module is configured to store the off-line transaction blog organized by the off-line transaction blog organizing module.

13. The Bluetooth financial IC card as claimed in claim 12, wherein said card further comprises a transaction authenticating module;
the transaction authenticating module is configured to receive a transaction authenticated instruction from the upper computer, to prompt a user to authenticate the transaction according to the transaction authenticated instruction, to authenticate transaction authenticated information input by the user after the transaction authenticated information input by the user is received, and to return an authentication successful response to the upper computer if the authentication is successful; otherwise, to return an authentication unsuccessful response to the upper computer if the authentication is unsuccessful.

14. The Bluetooth financial IC card as claimed in claim 13, wherein said card further comprises a storing module;
the storing module is configured to store fingerprint information;
the transaction authenticating module specifically includes that
a first receiving sub module, which is configured to receive a fingerprint authenticated instruction from the upper computer;
a first prompting sub module, which is configured to prompt a user to input fingerprint information after the first receiving sub module receives the fingerprint authenticated instruction from the upper computer;
a fingerprint information receiving sub module, which is configured to receive the fingerprint information input by the user; and
a fingerprint authenticating sub module, which is configured to authenticate the fingerprint information, which is input by the user, received by the fingerprint information receiving sub module according to fingerprint information stored by the storing module, to generate the authentication successful information and return the authentication successful information to the upper computer if the authentication is successful; otherwise, to generate authentication unsuccessful information and return the authentication unsuccessful information to the upper computer.

15. The Bluetooth financial IC card as claimed in claim 14, wherein
said card holder authenticating module is specifically configured to generate a third fingerprint eigenvalue according to the fingerprint information, input by the user, received by the fingerprint information receiving sub module, to encrypt the third fingerprint eigenvalue to obtain an encrypted third fingerprint eigenvalue in the case that the card holder authenticated method chosen by the choosing module is the on-line fingerprint authenticated type; and
the on-line transaction message organized by the on-line transaction message organizing and sending module includes the encrypted third fingerprint eigenvalue obtained by the card holder authenticating module.

16. The Bluetooth financial IC card as claimed in claim 14, wherein
the storing module is further configured to store the on-line identifying code;
the card holder authenticating module is specifically configured to generate a successful off-line fingerprint authenticated result according to the authentication successful information generated by the fingerprint authenticating sub module in the case that the card holder authenticated method chosen by the choosing module is the off-line fingerprint authenticated type; and
the on-line transaction message organized by the on-line transaction message organizing and sending module includes the successful off-line fingerprint authenticated result generated by the card holder authenticating module and the on-line identifying code stored by the storing module; or, the on-line transaction message organized by said on-line transaction message organizing and sending module includes that the successful off-line fingerprint authenticated result generated by the card holder authenticating module.

17. The Bluetooth financial IC card as claimed in claim 11, wherein said card further comprises a first storing module;
the first storing module is configured to store the off-line identifying code;
the card holder authenticating module specifically includes that
a third prompting sub module which is configured to prompt the user to input an off-line identifying code in the case that the card holder authenticated method chosen by the choosing module is the off-line identifying code authenticated type;
a third obtaining sub module which is configured to obtain the off-line identifying code input by the user; and
a third authenticating sub module which is configured to authenticate the off-line identifying code obtained by the third obtaining sub module from the user according to the off-line identifying code stored by the first storing module, and to generate the off-line identifying code authenticated result.

18. The Bluetooth financial IC card as claimed in claim 11, wherein said card further comprises a second storing module;
the second storing module is configured to store fingerprint information;
the card holder authenticating module specifically includes that
a fourth prompting sub module which is configured to prompt the user to input the fingerprint information in the case that the card holder authenticated method chosen by the choosing module is the off-line fingerprint authenticated type;
a fourth obtaining sub module which is configured to obtain the fingerprint information input by the user; and
a fourth authenticating sub module which is configured to authenticate the fingerprint information obtained by the fourth obtaining sub module according to the fingerprint information stored by the second storing module, and to generate the off-line fingerprint authenticated result.

19. The Bluetooth financial IC card as claimed in claim 11, wherein said card holder authenticating module specifically comprises that
a fifth prompting sub module which is configured to prompt the user to input fingerprint information in the case that the card holder authenticated method chosen by the choosing module is the on-line fingerprint authenticated type;
a fifth obtaining sub module which is configured to obtain the fingerprint information input by the user;
a fingerprint feature generating sub module which is configured to generate the third fingerprint eigenvalue according to the fingerprint information obtained by the fifth obtaining sub module from the user, to encrypt the third fingerprint eigenvalue so as to obtain the encrypted third fingerprint eigenvalue; and
the on-line transaction message organized by the on-line transaction message organizing and sending module includes the encrypted third fingerprint eigenvalue obtained by the fingerprint feature generating sub module.

20. The Bluetooth financial IC card as claimed in claim 11, wherein said card holder authenticating module specifically comprises that
a sixth prompting sub module which is configured to prompt the user to input the on-line identifying code in the case that the card holder authenticated method chosen by the choosing module is the on-line identifying code authenticated type;
a sixth obtaining sub module which is configured to obtain the on-line identifying code input by the user;
a sixth encrypting sub module which is configured to encrypt the on-line identifying code obtained by the sixth obtaining sub module from the user so as to obtain the encrypted on-line identifying code; and
the on-line transaction message organized by said on-line transaction message organizing and sending module includes the encrypted on-line identifying code obtained by the sixth encrypting sub module.
